(19) United States
(12) Patent Application Publication
(10) Pub. No.: US 2003/0043118 A1
(43) Pub. Date: Mar. 6, 2003

(54) Compact keyboard for handheld computer

(76) Inventor: Sang Min Lee, Fort Collins, CO (US)

Correspondence Address: Delphine M. James, #170, 2656 South Loop West, Houston, TX, 77054, US

(21) Appl. No.: 09/940,210

(22) Filed: Aug. 28, 2001

(51) Int. Cl. G09G 5/00

(52) U.S. Cl. 345/168

(57) ABSTRACT

A handheld computerized device which features a compact keyboard portion hingedly connected to an electronic housing. The front edge of the keyboard portion is hingedly connected to the front edge of the electronic housing which allows the keyboard portion is pivoted 360 degrees around the longitudinal axis of the electronic housing. After the keyboard portion is pivoted 360 degrees, this embodiment of the present invention is placed in an operable position in which the bottom surface of the keyboard portion is parallel to the bottom surface of the electronic housing. Another alternative embodiment features the keyboard portion securely attached to the electronic housing in an operable position. Another alternative embodiment features a sliding bracket utilized to secure the keyboard portion in an operable position.

### BACKGROUND

The present invention relates to keyboards for computer devices. More particularly, keyboard accessories for handheld computer devices.

In recent years, Personal Digital Assistants (PDAs) have gained popularity. Miniaturization of electronic components has made PDAs increasingly powerful, versatile, and affordable. PDAs fall into two categories hand-held computers and palm size computers. Hand-held computers are larger and heavier than palm size computers. The two most common methods of data entry for PDAs are:

1. Minatured portable keyboard

2. Tapping on an “on-screen software keyboard”

3. Handwriting recognition.

A tiny touch four-inch on-screen software keyboard serves as both an input and an output device. The tiny touch screen sits on top of the Liquid Crystals Display (LCD) similar to that found on a laptop. A user launches a program by tapping on the tiny screen with a pen-like stylus.

For handwriting recognition a plastic stylus is used to draw characters and numbers on the tiny touch screen. Software inside the PDA converts the characters to letters and numbers. For example, in most PDAs the handwriting recognition software is called Graffiti. Graffiti requires that each letter be recorded in one uninterrupted motion utilizing a specialized alphabet.

Tapping on a tiny touch screen and using handwriting recognition software are the two most common ways data is inputted into PDAs. However, there are times when data entry via a keyboard is necessary. Users of PDAs are generally comfortable with using keyboards for entering data into a computer. Also, most users of palm-sized computers are familiar with keyboard designs used on type writers and standard computers. Therefore, most handheld computer devices provide an I/O port to allow a full or reduced size keyboard to be attached for data entry.

For PDAs, what is needed is a keyboard that is compact, that is not separate and that has a familiar keyboard design.

### SUMMARY

This present invention is a handheld computerized device with an attached compact keyboard. In one embodiment of the present invention, the device consists of a keyboard portion and an electronic portion. The keyboard portion and the electronic housing both have a configuration defined by a top edge, bottom edge, top surface, bottom surface, and a pair of side edges. In this embodiment of the present invention, the top edge of the keyboard portion is aim hingedly connected to the top edge of the electronic housing. A keypad overlays the top surface of the keyboard portion and a display means overlays the top surface of the electronic housing. A microprocessor is situated inside the electronic housing and is electrically connected to keyboard the portion. The hinge connection between the keyboard portion and the electronic housing allows the keyboard portion to pivot from a closed position into an operable position. When in a closed position the keypad and display means are enclosed in a cavity formed by the closure of the keyboard portion against the electronic housing. To pivot into an operable position, the keyboard portion is pivoted 360 degrees around the longitudinal axis of the electronic housing such that the bottom surface of the keyboard portion becomes parallel to the bottom surface of the electronic housing.

In another embodiment of the present invention, the bottom surface of the keyboard portion is permanently affixed to the bottom surface of the electronic housing. In this embodiment the handheld device is fixed in its operable position.

In yet another embodiment of the present invention, the handheld device consists of a sliding bracket having a pair of guide members integrally coupled to the side edges of the electronic housing. The side edges of the keyboard portion are adapted to slide into the guide members. In this embodiment the handheld device is placed in an operable by sliding the keyboard portion with the bottom surface of the keyboard portion parallel to the bottom surface of the electronic housing.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a perspective side view of one embodiment of the present invention, a hand-held computerized device in an open position;

FIG. 2 illustrates a frontal view of the keyboard portion of the present invention;

FIG. 3 illustrates the electronic housing pivoting into the closed position for the embodiment of the present invention illustrated in FIG. 1;

FIG. 3A illustrates the closed position for the embodiment of the present invention illustrated in FIG. 1;

FIG. 4 illustrates a frontal view of the electronic housing for the display means and the front panel;

FIG. 4A illustrates a frontal view of the electronic housing having an alternative structure for the pair of hand support braces;

FIG. 5 illustrates an internal schematic diagram of the electrical connections of the processor to the display means, the keypad and the additional keys on the front panel;

FIG. 6 illustrates a side perspective view of an alternative embodiment for the present invention;

FIGS. 7, 7A, 7B, and 7C illustrate a side perspective view of another alternative embodiment for the present invention;

### DETAILED SPECIFICATION

### Definitions

Ergonomic—Equipment design intended to reduce operator fatigue and discomfort.

QWERTY Keyboard Format—standard keyboard arrangement used on keyboards.

I/O Pin Connector—provide power to the keyboard and carries data from the keyboard to the computer.

Keyboard Controller—is an integrated circuit whose job is to monitor the data communication port and process all of the data that comes from the keyboard and forward it to the operating system.

Operating System—software designed to control the hardware of a specific computer system.

### Description

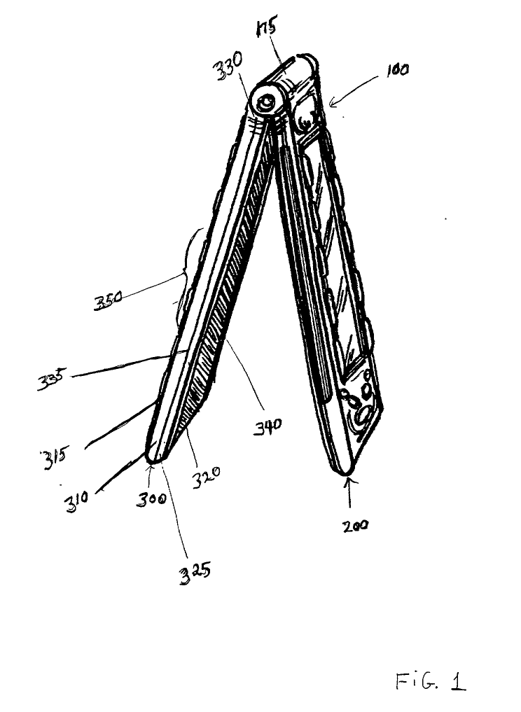

Referring initially to FIG. 1, an overall perspective side view of one embodiment of the present invention is seen, a handheld computerized device (100) in an open position. Device (100) can be a Personal Digital Assistant (PDA), Palm Computer or another portable computer with a similar architecture. The present invention in no manner is limited by the particular structure, function, logical architecture or compatibility of device (100).

In the illustrated embodiment, device (100) comprises keyboard portion (300) and electronic housing (200). Keyboard portion (300) is depicted having a support base (310) and keypad (350). Support base (310) is depicted having a rectangular configuration with a top surface (315), a bottom surface (320), a rear edge (325), a front edge (330), and a pair of side edges (335, 340). Keypad (350) consists of a plurality of keys overlaying the top surface (315) of support base (310). Support base (310) is preferably made of hard plastic and contains conventional electronic circuitry to control the functionality of the keypad (350). In the kind of embodiment, keyboard portion (300) is as thin as possible with a size and weight that is acceptable for a conventional handheld computing device. Additionally, the physical dimensions of keyboard portion (300) and electronic housing (200) are substantially equivalent.

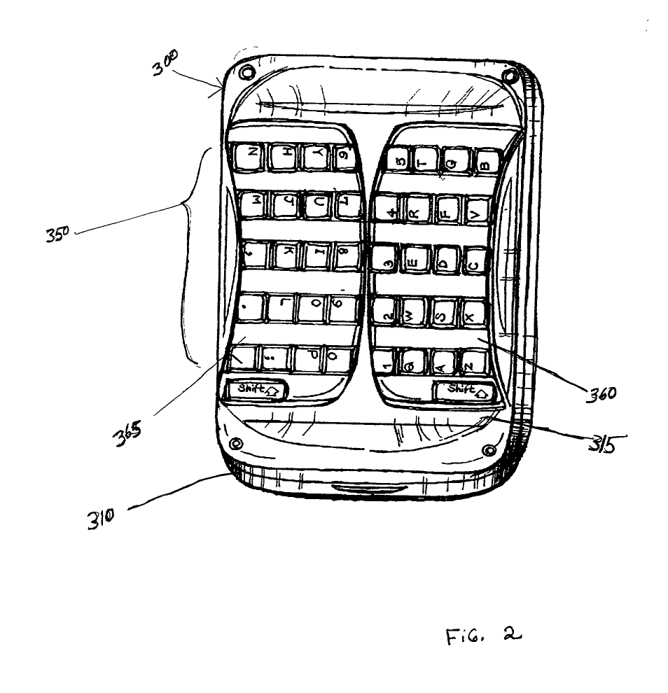

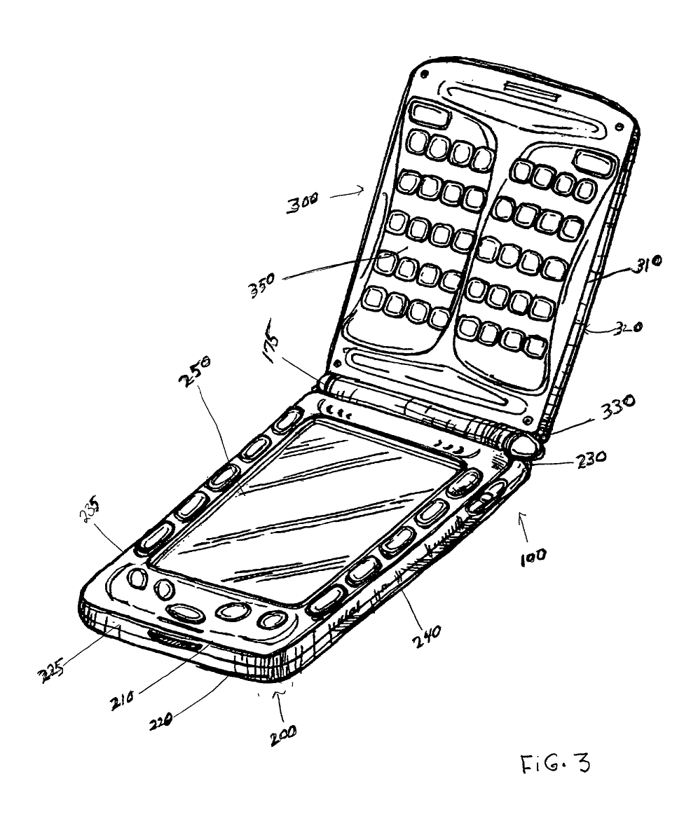

Referring now to FIG. 2, an exploded top view of the keyboard portion (300) is shown. In the illustrated embodiment, keyboard portion (300) further includes keypad (350) having a first section (360) and a second section (365). The first section (360) and second section (365) each have a plurality of alphanumeric keys in which a character signal is generated when each key is depressed. In the illustrated embodiment shown in FIG. 3, the first section (360) and second section (365) are in the form of complementary symmetrical parabolas. Additionally, first section (360) and second (365) section lie parallel to each other along the vertical plane of the top surface (315) of the support base (310) of the keyboard portion (300). The design feature of complementary symmetrical parabolas are ergonomic for placement of both hands while typing on keypad (350).

In the illustrated embodiment in FIG. 2, keypad (350) is arranged in the standard QWERTY format. The first section (360) of the keypad (350) is arranged in the standard QWERTY keyboard format for the left hand. Additionally, the second section (365) of the keypad (350) is arranged in the standard QWERTY keyboard format for the right hand.

Referring now to FIG. 3, there is illustrated device (100) with keyboard portion (300) pivoted at a 90 degree angle with electronic housing (200). In the illustrated embodiment, device (100) further comprises electronic housing (200) having a rectangular configuration with a top surface (210), a bottom surface (220), a rear edge (225), a front edge (230), and a pair of side edges (235, 240). The front edge (230) of the electronic housing (200) is coupled to the front edge (330) of the support base (310) of the keyboard portion (300) by hinge structure (175). The hinge structure (175) allows the keyboard portion (300) to pivot into the open position depicted in FIG. 1. In the depicted open position in FIG. 1, keyboard portion (300) is pivoted 360 degrees around the longitudinal axis of electronic housing (200). After keyboard portion (300) is pivoted 360 degrees, the bottom surface (220) of the electronic housing (200) becomes parallel to the bottom surface (320) of the keyboard portion (300). In order for device (100) to move into the closed position, again keyboard portion (300) is pivoted 360 degrees around the longitudinal axis of electronic housing (200). As the keyboard portion (300) is pivoted, the keypad (350) and the display means (250) are enclosed within the cavity formed by the closure of electronic housing (200) against keyboard portion (300) as illustrated in FIG. 3A.

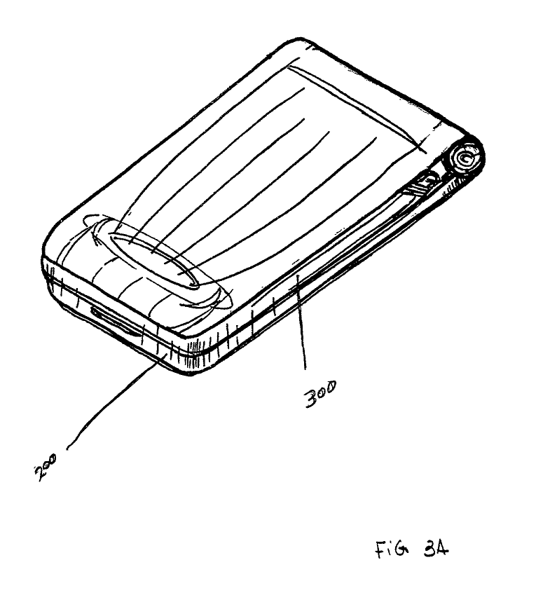

Referring now to FIG. 4, there is illustrated an exploded front view of electronic housing (200). In the illustrated embodiment, overlaying the top surface (210) of electronic housing (200) is display means (250) surrounded by a front panel (270). For example, with PDAs, display means (250), can be Liquid Crystals Display (LCD), or a similar architecture.

In the illustrated embodiment in FIG. 4, display means (250) is shown having a display area (251) with a top edge (252), bottom edge (253), and a pair of side edges (254, 255). Additionally, front panel (270) is shown having a top strip (271), bottom strip (272), and a pair of side strips (273,274). Each strip of the front panel (270) lies adjacent to and is securely attached to its corresponding edge of the display area (251). In the illustrated embodiment, the bottom strip (272) and each side strip (273, 274) of the front panel (270) further comprises a plurality of additional alphanumeric keys (280). Each additional alphanumeric key is also adapted to generate or to assist to generate a character signal when the key is depressed.

The illustrated embodiment in FIG. 4 depicts one possible configuration of the additional alphanumeric keys (280) along the front panel (270). The keys can be either numeric keys, function keys or control keys. The numeric keys are for numeric data entry. For example, using the depicted configuration, pressing the keys labeled 0-9, would generate the character signal corresponding to the number 0-9. Control keys provide cursor and screen control. For example, with this depicted configuration, simultaneously pressing <ctrl> <page up> would put the cursor at the top left corner of the display area (251). However, function keys can be assigned specific functions by an executing application or the operating system of the hand-held computer. For example, a word processing program executing on device (100) have programmed the simultaneous pressing of <func> <1> to be equivalent to the simultaneous pressing of <ctrl> <page-up>. Then, pressing <func> <1> simultaneously while the word processing program is executing on device (100) would put the cursor at the top left corner of the display area (251).

The embodiment illustrated in FIG. 4. further comprises a pressure sensitive writing means (290). The pressure sensitive writing means (290) is a small commercially available tiny touch screen overlaying the bottom of display area (251). In this kind of embodiment, a user utilizing a stylus pen outlines letters and numbers onto the tiny touch screen (290). Software executing inside device (100) recognizes the letters and numbers outlined on the tiny touch screen (290). After the software recognizes the letters and numbers, they are displayed in display area (251). For example, as shown, the letters “a” and “b” are outlined onto the tiny touch screen (290) and the actual letters “a” and “b” are displayed in display area (251). For example, with PDA's devices, the software that recognizes letters outlined on the tiny touch screen (290) is called Graffiti.

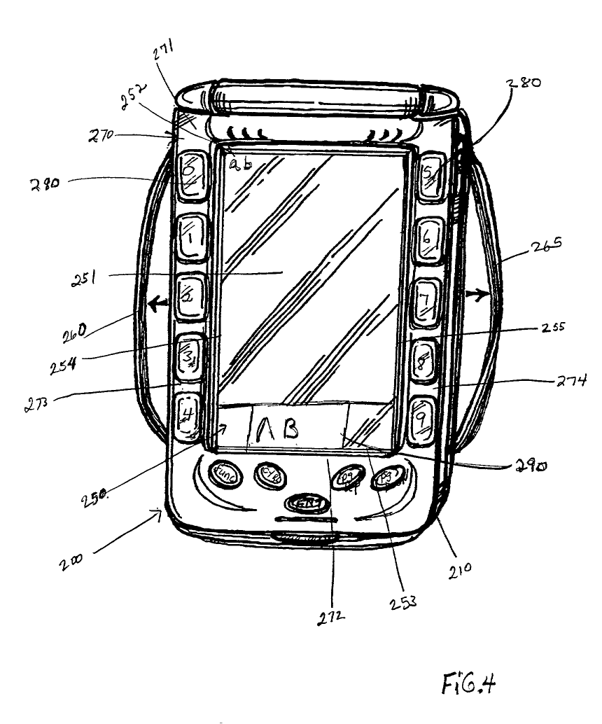

Referring now to FIG. 5, for this kind of embodiment, an internal schematic diagram of the electronic housing (200) is shown. In the illustrated embodiment, processor (400) is situated within the electronic housing (200). Processor (400) is electrically connected to the display means (250), keyboard portion (300), and the additional alphanumeric keys (280). In this kind of embodiment, when the additional alphanumeric keys (280) and the keys at the keypad (350) are pressed, the generated character signal for the depressed key is transmitted through the electrical connection (410) to the processor (400). For example, this electrical connection (410) can be an I/O pin connector (e.g. 4 pin-USB (Universal Serial Bus) connector) attached to a data communication port which is monitored by the keyboard controller (420), device driver software. The keyboard controller (420) software receives the input data from the keyboard portion (300) and communicates with the operating system (430) which forwards the input data to the current application (440) which displays the inputted data onto the display means (250).

In this kind of embodiment, the processor (400) interprets the generated character signal transmitted to it from the keyboard portion (300). If the generated signal is a letter or number, then it is displayed by the display means (250). However, if the generated signal is a function key or a control key, the requested function is performed by the processor (400).

Referring back to FIG. 4, there is illustrated device (100) with a pair of hand support braces (260, 265) attached at an ergonomic position along each side edge (235, 240) of electronic housing (200). In the illustrated embodiment, each hand support brace is made of strong elastic band about 2 inches in width. In the illustrated embodiment, the left or right or both hands are placed within each elastic band. The elastic bands stretch to support and to hold in place the right and left hands while a user is typing. A possible alternative structure for the pair of hand support braces (260, 265) illustrated in FIG. 4A is a pair of grooves. The pair of grooves are securely attached at an ergonomic position along each side edge (235, 240) of electronic housing (200) as the pair of hand support braces (260, 265). The grooves can be made of sturdy soft plastic material. In the illustrated embodiment, the left and right hands are placed around the grooves and are supported while a user is typing. The illustrated embodiments for the hand support braces are in no manner limited to the above disclosed structures.

When device (100) is used, the device (100) is first pivoted from the closed position shown in FIG. 3A into the open position depicted in FIG. 4. The left and right hand are placed within hand braces (260, 265) shown in FIG. 4. Then, left hand is placed upon the first section (360) of keypad (350) shown is FIG. 2 and the right hand is placed upon the second section (365) of keypad (350) shown in FIG. 2. The thumbs of the left and right hand are used to control the alphanumeric keys (280) on front panel (270) shown FIG. 4.

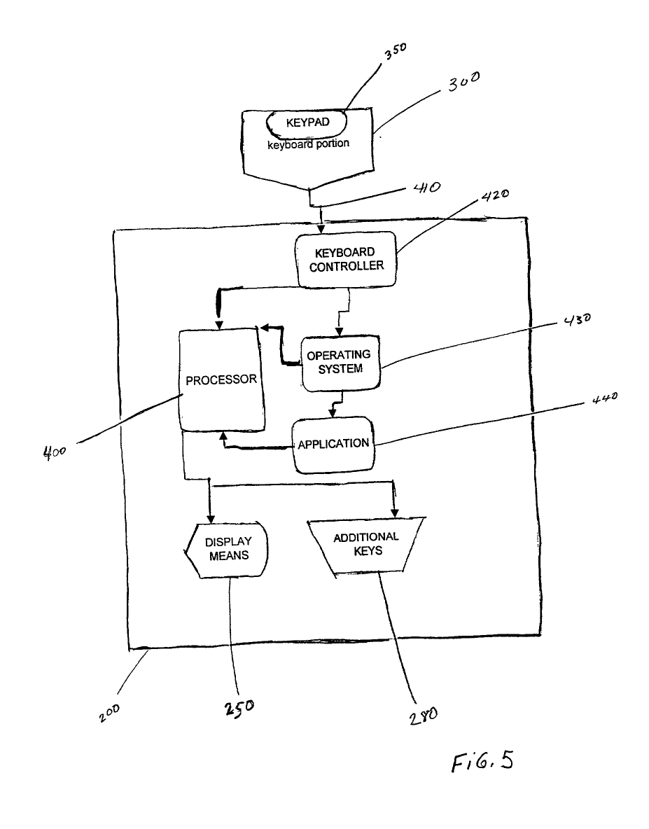

Referring now to FIG. 6, an overall perspective side view of an alternative embodiment of the present invention is seen, a handheld computerized device (600) in an open position. Device (600) can be a Personal Digital Assistant (PDA), Palm Computer or another portable computer with a similar architecture. The present invention in no manner is limited by the particular structure, function, logical architecture or compatibility of device (600).

In the illustrated embodiment, device (600) comprises keyboard portion (610) and electronic housing (620). Keyboard portion (610) is depicted having a support base (615) and keypad (625). Support base (615) is depicted having a configuration defined by a top surface (630), front edge, back edge, pair of side edges, and a bottom surface (635). Keypad (625) is shown overlaying the top surface (630) of support base (615).

In the illustrated embodiment, device (600) further comprises electronic housing (620) having a configuration defined by a top surface (640), front edge, back edge, pair of side edges, and a bottom surface (645). As illustrated in the embodiment, the bottom surface (645) of electronic housing (620) is permanently affixed to the bottom surface (635) of the support base (615) of the keyboard portion (610). In the illustrated embodiment device (600) is fixed in an operable position. Except for the fixation of the bottom surface (645) of electronic housing (620) to the bottom surface (635) of support base (615), electronic housing (620) and keyboard portion (610) are structurally equivalent and functionally equivalent to electronic housing (200) and keyboard portion (300) of device (100) shown in FIG. 1. Additionally, with this alternative embodiment, the internal schematic diagram illustrated in FIG. 5 for electronic housing (200) is also supported by electronic housing (620).

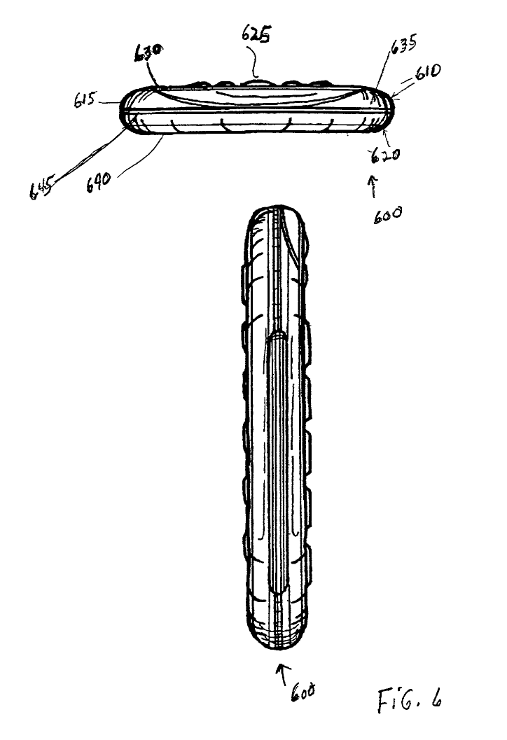

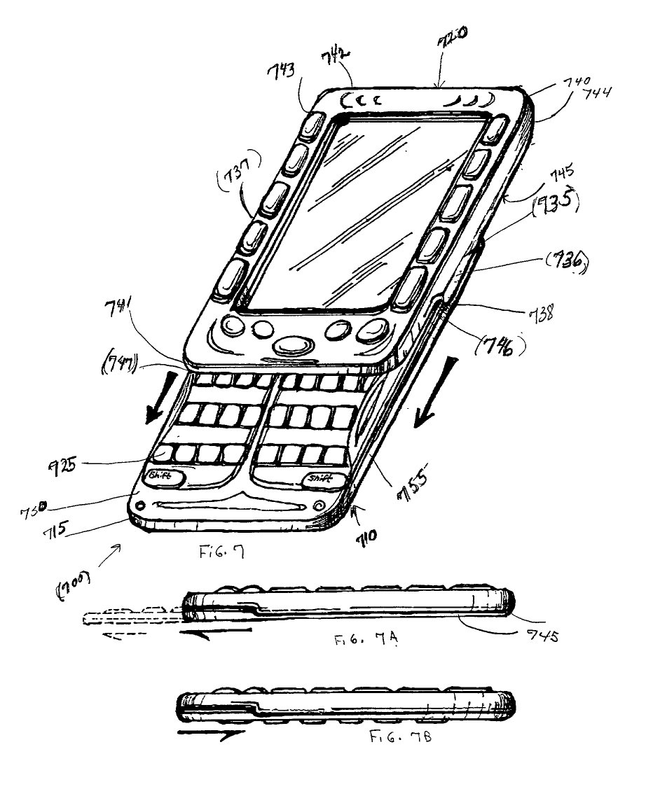

Referring now to FIG. 7, an overall perspective side view of another alternative embodiment of the present invention is seen, a handheld computerized device (700) in an open position. Device (700) can be a Personal Digital Assistant (PDA), Palm Computer or another portable computer with similar architecture. The present invention in no manner is limited by the particular structure, function, logical architecture or compatibility of device (700).

In the illustrated embodiment, device (700) comprises keyboard portion (710) and electronic housing (720). Keyboard portion (710) is depicted having a support base (715) and keypad (725). Support base (715) is depicted having a rectangular configuration with keypad (725) overlaying the top surface (730) of support base (715).

In the illustrated embodiment, device (700) further comprises a sliding bracket (735) having a pair of guide members (736, 737) and a corresponding pair of ribs (746, 747). As shown in the illustrated embodiment, each guide member (736, 737) is composed of a rectangular strip having a groove (738) along its inner horizontal plane. In this kind of embodiment, each side edge (755) of support base (715) is adapted with ribs (736, 737) that is configured to slide into the groove (738) of each corresponding guide member (736, 737). As shown FIG. 7A and FIG. 7B, after the keyboard portion (710) is completely slid into the guide members (736, 737), the keyboard portion (710) is securely held in place.

In the illustrated embodiment, device (700) further comprises electronic housing (720) having a rectangular configuration with a top surface (740), bottom surface (745) top edge (741), bottom edge (742), and a pair of side edges (743, 744). As illustrated in the embodiment, the pair of side edges (743, 744) of the electronic housing are integrally coupled to the pair of guide members (736, 737). With this alternative embodiment except for the addition of the sliding bracket (735), electronic housing (720) and keyboard portion (710) are structurally equivalent and functionally equivalent to electronic housing (200) and keyboard portion (300) of device (100) shown in FIG. 1. Additionally, with this alternative embodiment, the internal schematic diagram illustrated in FIG. 4 for electronic housing (200) is also supported by electronic housing (720).

As shown in FIG. 7C, when device (700) is used, it is placed in an operable position by sliding ribs (746, 747) into guide members (735, 737) with the bottom surface (760) of keyboard portion (710) parallel to the bottom surface (745) of electronic housing (720). Then, a user would place their left or right or both hands in the hand support braces (770, 772) while the user is typing at the keypad (725). After the user is finished using device (700), the keyboard portion (710) is slid into guide members (735, 737) with the keypad (725) facing the bottom surface (765) of electronic housing (720) as shown in FIG. 7B.

While only certain embodiments of the invention have been illustrated and described, it is understood that alterations, changes, and modifications may be made without departing from the true scope and spirit of the invention.

What is claimed is:

1. A handheld computerized device comprising:
a keyboard portion having a support base and a keypad, the support base defined by a top surface, a bottom surface, a rear edge, a front edge, and a pair of side edges, the keypad overlaying the top surface of the support base;
an electronic housing having a configuration defined by a top surface, a bottom surface, a rear edge, a front edge, and a pair of side edges, the front edge of the electronic housing being hingedly coupled to the front edge of the support base such that the electronic housing can pivot from a closed position into an open position wherein the bottom surface of the electronic housing is parallel to the bottom surface of the support base;
a pair of hand support means being securely attached at an ergonomic position along each side edge of the electronic housing, whereby a user's left hand or right hand or both hands are supported while the user is typing on the keypad;
a means for displaying data overlaying the top surface of the electronic housing; and
a processor situated within the electronic housing, the processor electrically connected to the display means and the keyboard portion whereby data entered at the keypad is transmitted to the processor and displayed by the display means.

2. The device recited in claim 1, wherein the keypad further comprises:
a first and a second section having a plurality of alphanumeric keys each adapted to generate a character signal upon depression thereof, each section being in the form of complementary symmetrical or asymmetrical parabolas;
the first and the second section lying co-planar vertically parallel along the top surface of the support base of the keyboard portion;
the first section of the keypad being arranged in the standard QWERTY keyboard format for the left hand; and
the second section of the keypad being arranged in the standard QWERTY keyboard format for the right hand.

3. The device recited in claim 1, wherein the display means further comprises:
a display area defined by a top edge, bottom edge, and a pair of side edges;
a front panel surrounding the display area and being defined by a top strip, a bottom strip, and a pair of side strips; and
each edge of the display area lying adjacent to and being securely attached to each corresponding strip of the display area.

4. The device recited in claim 3 wherein the display area is a Liquid Crystals Display (LCD).

5. The device recited in claim 3, wherein the bottom strip and each side strip of the front panel further comprises:
a plurality of additional alphanumeric keys each adapted to generate a character signal upon depression thereof; and
a means for electrically connecting the plurality of additional alphanumeric keys to the processor whereby each generated character signal is transmitted to the processor.

6. The device recited in claim 1, further comprising:
a pressure sensitive writing means for allowing data to be inputted via handwriting; and the pressure sensitive writing means overlapping the bottom edge of the display area.

7. A handheld computerized device comprising:
a keyboard portion having a support base and a keypad, the support base including a top surface, a bottom surface, a rear edge, a front edge, and a pair of side edges, the keypad overlaying the top surface of the support base;
an electronic housing having a configuration with a top surface, a bottom surface, a rear edge, a front edge, and a pair of side edges, the bottom surface of the electronic housing being securely attached to the bottom surface of the keyboard portion;
a pair of hand support means being securely attached at an ergonomic position along each side edge of the electronic housing, whereby a user's left hand or right hand or both hands are supported while the user is typing on the keypad;
a means for displaying data overlaying the top surface of the electronic housing; and
a processor situated within the electronic housing, the processor electrically connected to the display means and the keyboard portion whereby the data entered at the keypad is transmitted to the processor and displayed by the display means.

8. The device recited in claim 7, wherein the keypad further comprises:
a first and a second section having a plurality of alphanumeric keys each adapted to generate a character signal upon depression thereof, each section being in the form of complementary symmetrical or asymmetrical parabolas;
the first and second section lying co-planar vertically parallel along the top surface of the support base of the keyboard portion;
the first section of the keypad being arranged in the standard QWERTY keyboard format for the left hand; and
the second section of the keypad being arranged in the standard QWERTY keyboard format for the right hand.

9. The device recited in claim 7, wherein the display means further comprises:
a display area defined by a top edge, bottom edge, and a pair of side edges;
a front panel surrounding the display area and being defined by a top strip, a bottom strip, and a pair of side strips; and
each edge of the display area lying adjacent to and being securely attached to each corresponding strip of the display area.

10. The device recited in claim 9 wherein the display area is a Liquid Crystals Display (LCD).

11. The device recited in claim 10, wherein the bottom strip and each side strip of the front panel further comprises:
a plurality of additional alphanumeric keys each adapted to generate a character signal upon depression thereof; and
a means for electrically connecting the plurality of additional alphanumeric keys to the processor whereby each generated character signal is transmitted to the processor.

12. The device recited in claim 7, further comprising:
a pressure sensitive writing means for allowing data to be inputted via handwriting; and the pressure sensitive writing means overlapping the bottom edge of the display area.

13. A handheld computerized device comprising:
a sliding bracket having a pair of guide members;
a keyboard portion having a support base and a keypad, the support base including a top surface, a bottom surface, a rear edge, a front edge, and a pair of side edges, the pair of side edges being adapted to slide into the pair of guide members, the keypad overlaying the top surface of the support base;
an electronic housing having a configuration with a top surface, a bottom surface, a rear edge, a front edge, and a pair of side edges, the pair of side edges being integrally coupled to the pair of guide members;
a pair of hand support means being securely attached at an ergonomic position along each side edge of the electronic housing, whereby a user's left hand or right hand or both hands are supported while the user is typing on the keypad;
a means for displaying data overlaying the top surface of the electronic housing; and
a processor situated within the electronic housing, the processor electrically connected to the display means and the keyboard portion whereby the data entered at the keypad is transmitted to the processor and displayed by the display means.

14. The device recited in claim 13, wherein the keypad further comprises:
a first and a second section having a plurality of alphanumeric keys each adapted to generate a character signal upon depression thereof, each section being in the form of complementary symmetrical or asymmetrical parabolas;
the first and second section lying co-planar vertically parallel along the top surface of the support base of the keyboard portion;
the first section of the keypad being arranged in the standard QWERTY keyboard format for the left hand; and
the second section of the keypad being arranged in the standard QWERTY keyboard format for the right hand;

15. The device recited in claim 13, wherein the display means further comprises:
a display area defined by a top edge, bottom edge, and a pair of side edges;
a front panel surrounding the display area and being defined by a top strip, a bottom strip, and a pair of side strips; and
each edge of the display area lying adjacent to and being securely attached to each corresponding strip of the display area.

16. The device recited in claim 15 wherein the display area is a Liquid Crystals Display (LCD).

17. The device recited in claim 15, wherein the bottom strip and each side strip of the front panel further comprises:
a plurality of additional alphanumeric keys each adapted to generate a character signal upon depression thereof; and
a means for electrically connecting the plurality of additional alphanumeric keys to the processor whereby each generated character signal is transmitted to the processor.

18. The device recited in claim 13, further comprising:
a pressure sensitive writing means for allowing data to be inputted via handwriting; and
the pressure sensitive writing means overlapping the bottom edge of the display area.
